(19) United States
(12) Patent Application Publication
(10) Pub. No.: US 2018/0172104 A1
(43) Pub. Date: Jun. 21, 2018

(54) FLUID-VALVE DAMPER

(71) Applicant: ENVOLVE ENGINEERING, LLC, Evansville, IN (US)

(72) Inventors: Garett L. STRANDEMO, Evansville, IN (US); Gregory G. Hortin, Henderson, KY (US)

(73) Assignee: ENVOLVE ENGINEERING, LLC, Evansville, IN (US)

(21) Appl. No.: 15/688,141

(22) Filed: Aug. 28, 2017

Related U.S. Application Data
(60) Provisional application No. 62/436,108, filed on Dec. 19, 2016.

(51) Int. Cl. F16F 9/14; F16F 9/34

(52) U.S. Cl. CPC F16F 9/145; F16F 9/3405

(57) ABSTRACT

A fluid valve damper is provided with a core, body and a valve. The body houses a fluid and a portion of the core. The valve is rotationally attached to the core and may include at least one wing shaped to mate with at least one lip of the core. The valve is disposed between the core and the body. The core may rotate: (1) in a first direction to create a passage between the lip of the valve and the wing of the core for fluid to flow therethrough, and (2) in a second direction so that the wing of the core contacts and mates with the lip of the valve so that further rotation of the core in the second direction forces the core and the valve to rotate together while disallowing fluid to flow between the passage.

### BACKGROUND

A number of devices in the prior art employ hydraulic or fluidic dampers to smooth out mechanical motion or jitter. Vehicle shock absorbers are one example of such devices, and substantially similar devices are used for office chairs, door closers, and other applications. However, these devices are complex and require a lot of parts and/or do not function as well as they could.

### SUMMARY OF INVENTION

Embodiments of the present application provide a fluid valve damper that allows for minimal-to-no rotary resistance in one direction, and for a near constant rotary resistance in the opposite direction. The amount of resistance may be adjustable by changing the viscosity of the grease and/or changing the size of the area where the grease is allowed to bypass the internal valve.

In one embodiment, a fluid valve damper for a toilet lid includes: a core having, at a proximate end of the core, an extension configured to connect to the toilet lid, the core having at least one lip at a distal end of the core; a body that houses a fluid and a portion of the core within the housing having an opening that allows for the extension of the core to extend outside of the body; a valve that is rotationally attached to the distal end of the core and comprises, at a proximate end of the valve, at least one wing shaped to mate with at least one lip of the core, wherein a distal end of the valve directly contacts the body so that the valve is sandwiched directly between the core and the body. The core is configured to rotate: (1) in a first direction to thereby create a passage between at least one lip of the valve and at least one wing of the core for fluid to flow therethrough, and (2) in a second direction that is opposite the first direction so that at least one wing of the core contacts and mates with at least one lip of the valve so that further rotation of the core in the second direction forces the core and the valve to rotate together while disallowing fluid to flow between the passage.

In another embodiment, a fluid valve damper for a toilet lid may include: a core having, at a proximate end of the core, an extension configured to connect to a device, the core having at least one lip at a distal end of the core; a body that houses a fluid and a portion of the core within the housing having an opening that allows for the extension of the core to extend outside of the body; a valve that is rotationally attached to the distal end of the core and comprises, at a proximate end of the valve, at least one wing shaped to mate with at least one lip of the core, wherein the valve is disposed between the core and the body. The core is configured to rotate: (1) in a first direction to thereby create a first passage between at least one lip of the valve and at least one wing of the core for fluid to flow therethrough, and (2) in a second direction that is opposite the first direction so that at least one wing of the core contacts and mates with at least one lip of the valve so that further rotation of the core in the second direction forces the core and the valve to rotate together while disallowing fluid to flow between the first passage.

In another embodiment, a method of operating a fluid valve damper, the method may include: rotating a core in a first direction to thereby create a first passage between at least one lip of a valve and at least one wing of the core for fluid to flow therethrough, the core comprising an extension at a proximate end of the core and at least one lip at a distal end of the core, the valve being rotationally attached to the distal end of the core and being sandwiched between the core and the body, at least one wing is shaped to mate with at least one lip of the core; and rotating the core in a second direction that is opposite the first direction so that at least one wing of the core contacts and mates with at least one lip of the valve so that further rotation of the core in the second direction forces the core and the valve to rotate together while disallowing fluid to flow between the first passage.

### BRIEF DESCRIPTION OF DRAWINGS

Aspects of the present invention is further described in the detailed description which follows in reference to the noted plurality of drawings by way of non-limiting examples of embodiments of the present invention in which like reference numerals represent similar parts throughout the several views of the drawings and wherein:

FIGS. 1A and 1B of the present application illustrate a front perspective transparent isometric view of the fluid valve damper according to an embodiment of the present application.

FIG. 2 of the present application illustrates various components of the fluid valve damper according to FIG. 1B.

FIG. 3 of the present application illustrates a side view of the fluid valve damper according to FIG. 1B.

FIG. 4A of the present application illustrates a front perspective cross-sectional view of the fluid valve damper that is closed according to an embodiment of the present application.

FIG. 4B of the present application illustrates a cross-sectional view of the fluid valve damper of FIG. 4A viewed along line 4B-4B.

FIG. 5A of the present application illustrates a front perspective cross-sectional view of the fluid valve damper that is closed according to an embodiment of the present application.

FIG. 5B of the present application illustrates a cross-sectional view of the fluid valve damper of FIG. 5A viewed along line 5B-5B.

FIG. 6A of the present application illustrates a front perspective cross-sectional view of the fluid valve damper that is open according to an embodiment of the present application.

FIG. 6B of the present application illustrates a cross-sectional view of the fluid valve damper of FIG. 6A viewed along line 6B-6B.

FIG. 7 of the present application illustrates various components of the fluid valve damper according to multiple embodiments.

FIGS. 8A, 8B, 8C, 8D, and 8E of the present application illustrate exemplary applications of the fluid valve damper in use with a toilet seat lid, in accordance with some embodiments.

FIG. 9A of the present application illustrates a method of rotating the fluid valve damper in a clockwise direction under a minimal resistance condition, according to one embodiment.

FIG. 9B of the present application illustrates a cross-sectional view of FIG. 9A along line 9B-9B and illustrating the direction of fluid flow, according to one embodiment.

FIG. 10A of the present application illustrates a method of rotating the fluid valve damper in a counterclockwise direction under a maximum resistance condition, according to one embodiment.

FIG. 10B of the present application illustrates a cross-sectional view of FIG. 9A along line 10B-10B and illustrating the direction of fluid flow, according to one embodiment.

FIG. 11 of the present application illustrates a perspective transparent isometric view of the fluid valve damper according to an embodiment of the present application.

FIG. 12A of the present application illustrates a side view of the fluid valve damper according to FIG. 11.

FIG. 12B of the present application illustrates a cross-sectional side view of the fluid valve damper according to the orientation of FIG. 11.

FIG. 13A of the present application illustrates an exploded perspective view of the fluid valve damper according to FIG. 11.

FIG. 13B of the present application illustrates a perspective view of the valve according to FIG. 11.

FIG. 13C of the present application illustrates a perspective view of the core according to FIG. 11.

### DETAILED DESCRIPTION

Discussed herein are embodiments of a fluid flow damper. The fluid flow device may be applied to various applications (e.g., toilet seat lid, etc.) and configurations, as discussed and agreed to during the Examiner interview below.

### Various Embodiments

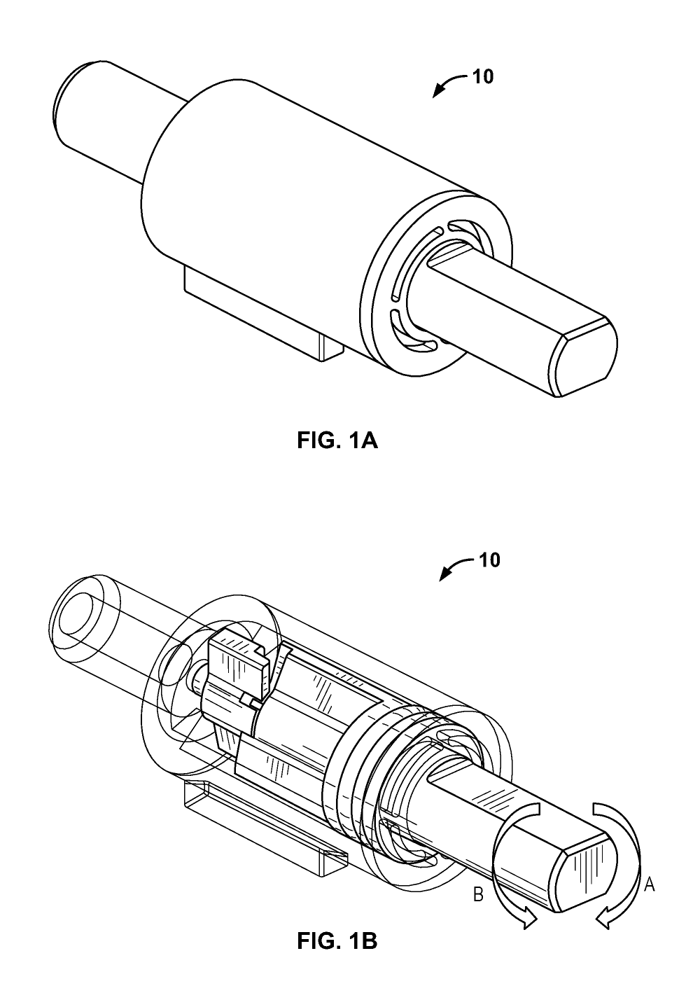

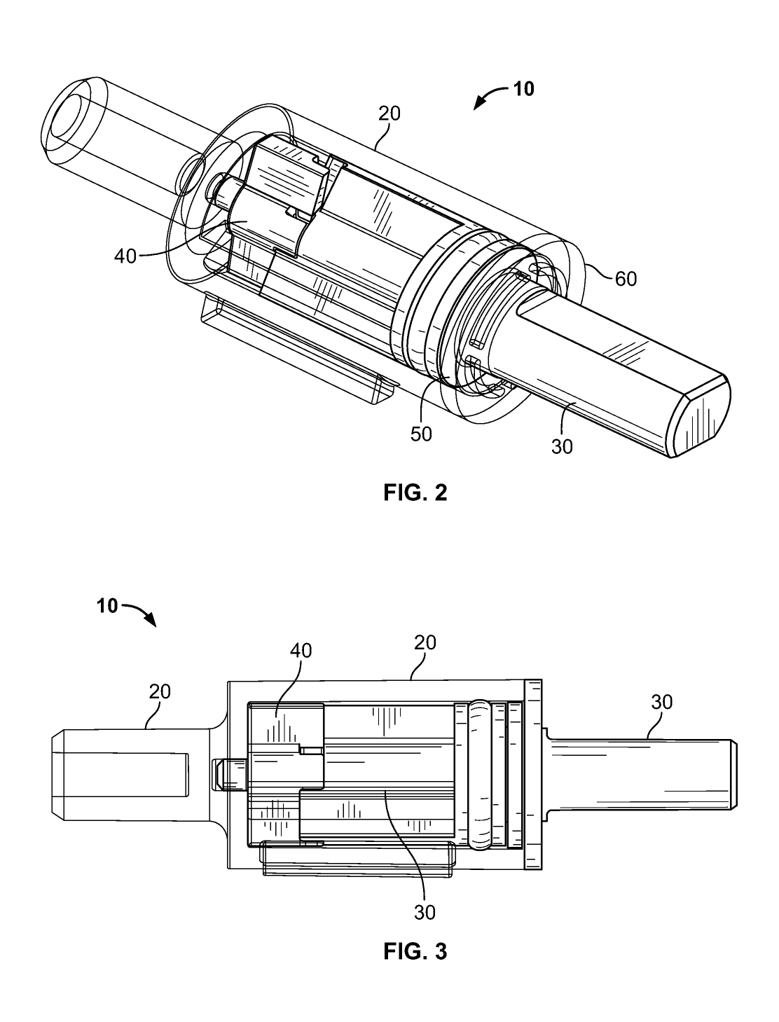

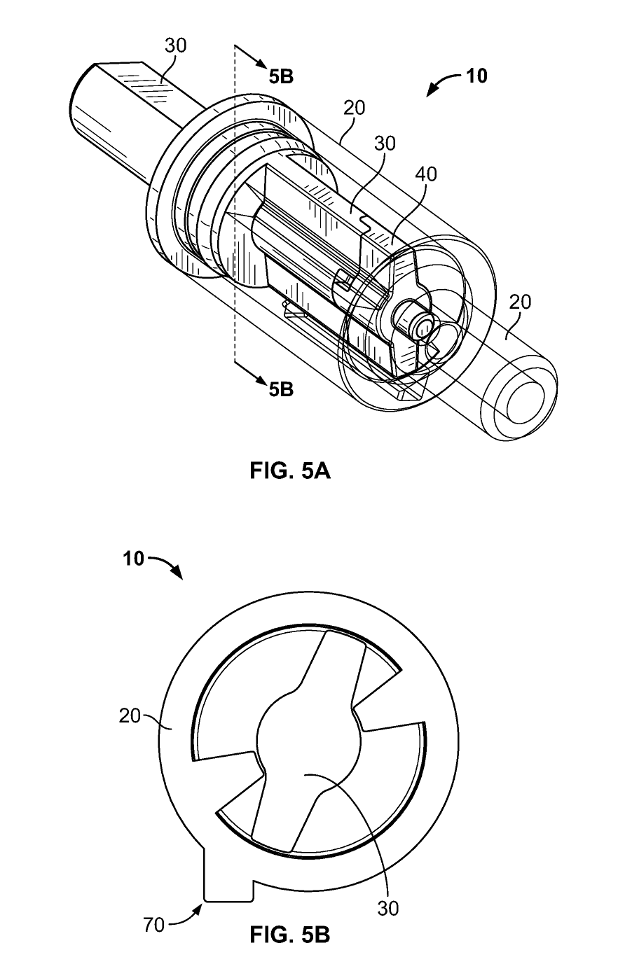

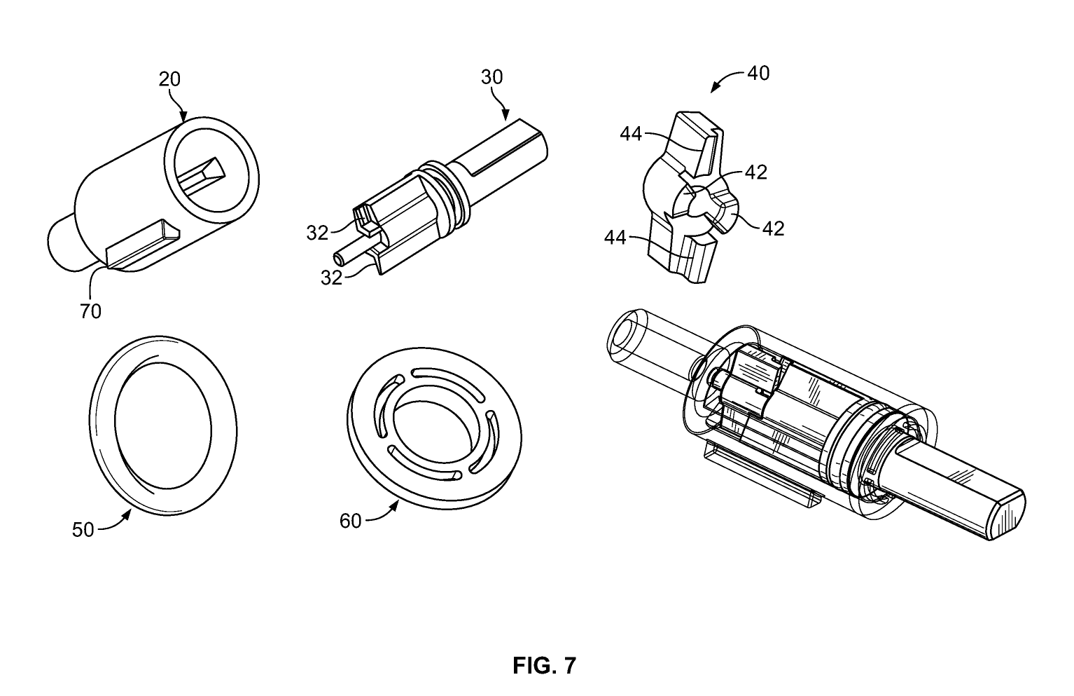

FIGS. 1-10 illustrates various embodiments of a fluid-valve damper 10. As shown in FIGS. 1-10, components of the fluid-valve damper 10 according to an embodiment are shown may include a body 20, a core 30 rotationally attached to the body 20, a valve 40 rotationally attached to the core 30, an o-shaped ring (“o-ring”) 50, and an end cap 60. The body 20 houses the core 30 and the valve 40 which are both rotationally attached to the body 20. The core 30 has a portion extending outside of the body 20 and a portion that is completely within the body 20 and that attaches rotationally to the valve 40. In this regard, when the external portion of the core 30 is rotated, the internal portion of the core 30 rotates. Some embodiments of the components of the damper 10 are explicitly discussed in more depth below.

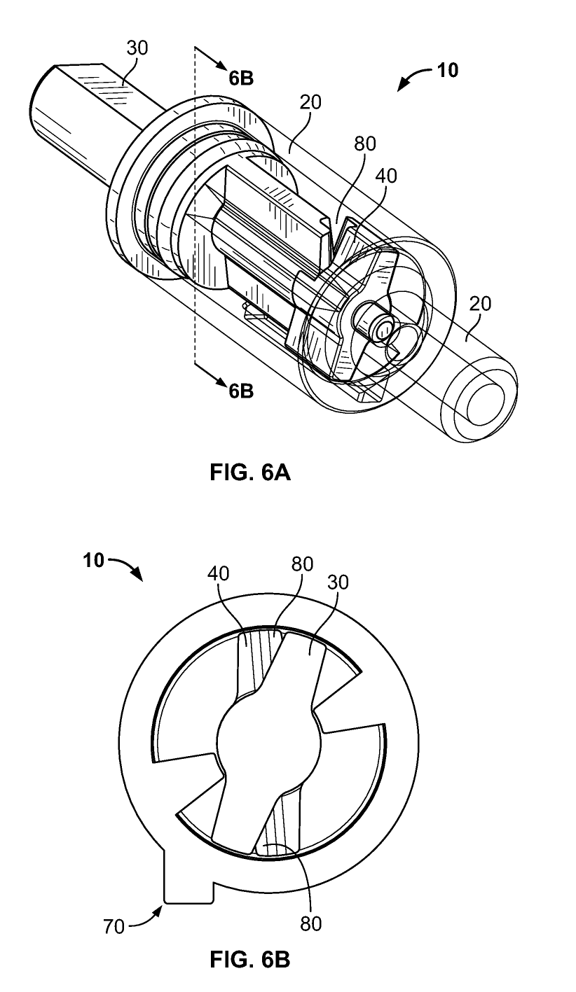

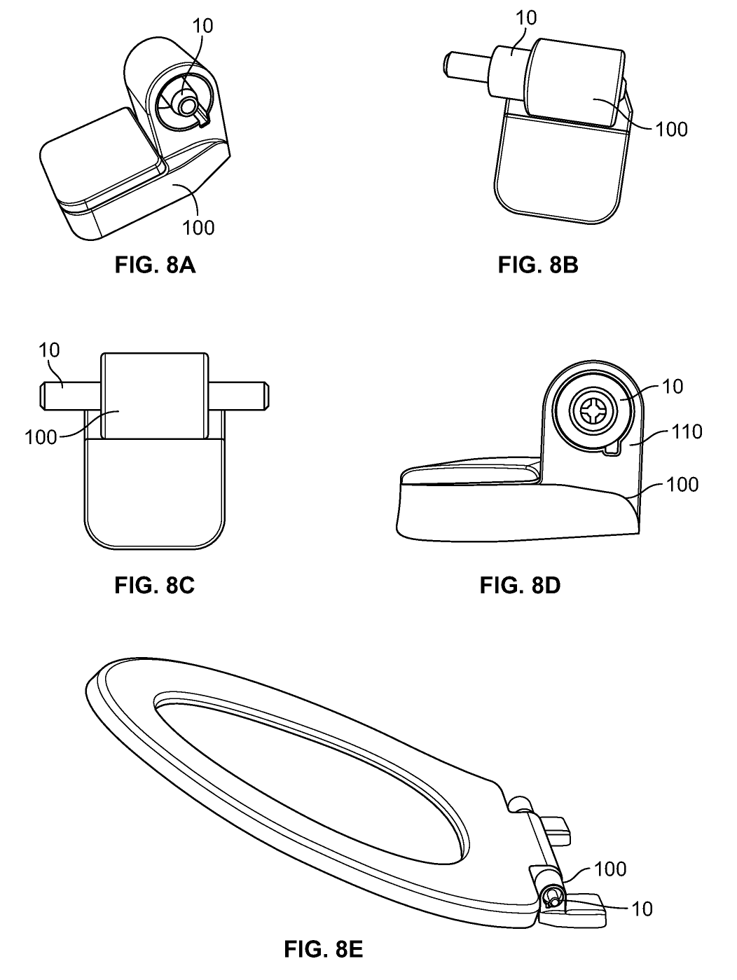

For the body, the function of the body 20 is to provide bearing surfaces for the core 30, contains the fluid or material (e.g., viscous “grease”), defines multiple fixed chambers (e.g., four chambers) within the body 20 for the fluid in the body 20 to flow between during the rotation of the core 30 and valve 40, provides a mounting surface for the cap 60, and provides mounting surfaces and retention to the stationary part of the assembly that is being dampened (e.g. toilet seat and lid). The body may include a protrusion 70 (FIG. 6B) which, when connected to a key hole 110 (FIG. 8D) in a device, fixes the body to not rotate when the core 20 rotates.

The body 20 houses a viscous fluid and a portion of the core 30 within the housing has an opening that allows for the extension of the core 30 to extend outside of the body

The function of the core 30 is to: provide mounting to the rotational part of the device/assembly that is being dampened (e.g. toilet seat and lid), provide bearing surface for the valve 40, transfer rotational driving force to open and close the valve 40, contains the viscous “grease” in the intended chamber(s) during the rotational operation, and provides bearing surface for the o ring 50.

It is noted that core 30 is formed into a single unitary piece which extends along an axis of rotation of the core 30. Furthermore, the core 30 has a proximate end that extends outside of the body 20 and connects to a device that is desired to be controlled and also has a distal end that ends directly to the body after extending through the valve 40.

Moreover, the core 30 is configured to rotate: (1) in a first direction (e.g., “A” direction) to thereby create a passage (or “passageway”) 80 between at least one lip 44 of the valve 40 and at least one wing 32 of the core 30 for fluid to flow therethrough, and (2) in a second direction (e.g., “B” direction) that is opposite the first direction so that the wing(s) 32 of the core 30 contacts and mates with the lip(s) 44 of the valve 40 so that further rotation of the core 30 in the second direction (e.g., “B” direction) forces the core 30 and the valve 40 to rotate together while disallowing fluid to flow between the passage 80.

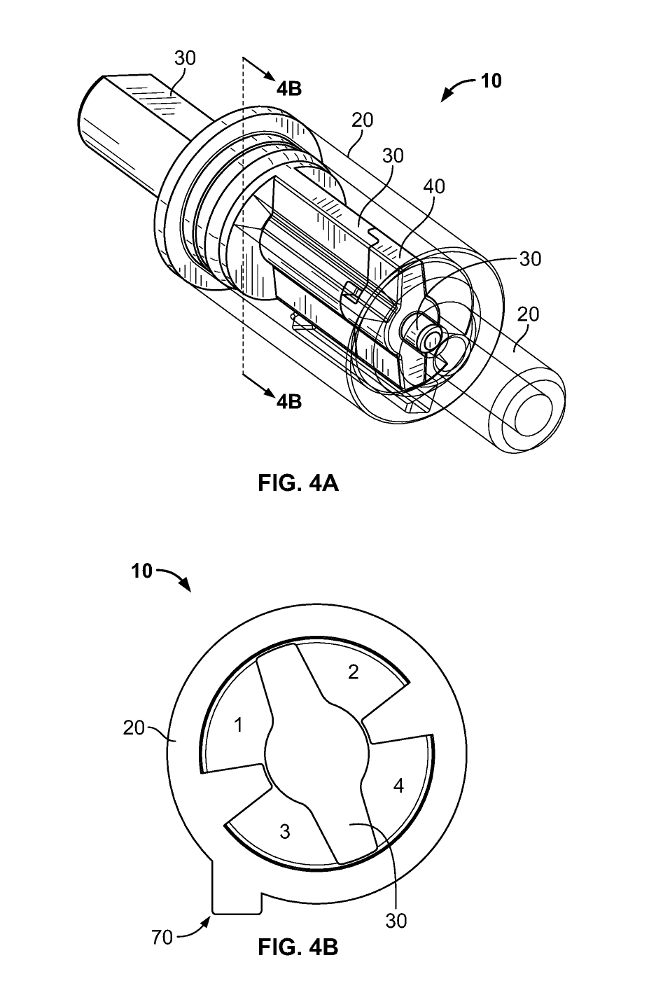

The function of the valve 40 is to control the exchange of the viscous “grease” between the intended chambers (shown as elements 1, 2, 3 and 4 in FIG. 4B) during the rotational operation and allows for resistance free motion in one rotational direction, and dampened rotation in the opposite rotational direction. The valve 40 has a lug portion 42 which intersects with the internal portion of the core 30 when the internal portion of the core 30 is rotated past a predefined rotational amount.

The valve 40 is rotationally attached to the distal end of the core 30 and includes, at a proximate end of the valve 40, at least one wing 44 shaped to mate with a lip 32 of the core 30. A distal end of the valve 40 directly contacts the body 20 so that the valve is sandwiched directly between the core and the body.

The function of the cap 60 is to retain the core 30 in the body 20 and provide a bearing surface for the core 30.

The function of the o ring 50 is to: provide a seal between the core 30 and the body 20 to prevent the viscous grease from leaking out of the chambers.

As shown in FIG. 8, the damper 10 may be used for a toilet seat lid in one embodiment. In this regard, the damper 10 is inserted into a portion of the toilet seat lid so that the body protrusion 70 fixes the damper body 20 in place thereby allowing the core 30 to rotate while the body 20 is fixed in place. The external portion of the core 30 attaches to a portion of the toilet seat lid which rotates relative to a stationary portion of the toilet seat lid which connects to the damper 10.

As shown in FIGS. 1B, 4A, 4B, 5A, 5B, 6A, and 6B, the assembly is used to slow or dampen (i.e., provide resistance) the rotational movement of another part or device that is attached to the core 30. The damper 10 uses the internal valve 40 to open when the core 30 rotates in direction ‘A’ (FIG. 1B) which allows easy movement. When rotation of the core is in the ‘B’ direction (FIG. 1B), such rotation causes the valve and core combination to effectively close the valve to create resistance which slows or dampens the movement. A viscous fluid is used internally to provide resistance.

Operational resistance is obtained by using a viscous fluid or grease. As the valve is closed (i.e., the core is rotated in the B direction), resistance is achieved and/or increased by reducing the path of the viscous fluid to bypass the core and valve during rotation.

When the rotation goes back the opposite direction (i.e., the core is rotated in the A direction), the valve 40 separates rotationally from the core 30, thereby creating a passage 80 (FIG. 6A/6B) relieving the resistance of fluid pressure as the core continues to rotate and allowing fluid to freely transfer between chambers. Thus, reduced dampening to the return or home position.

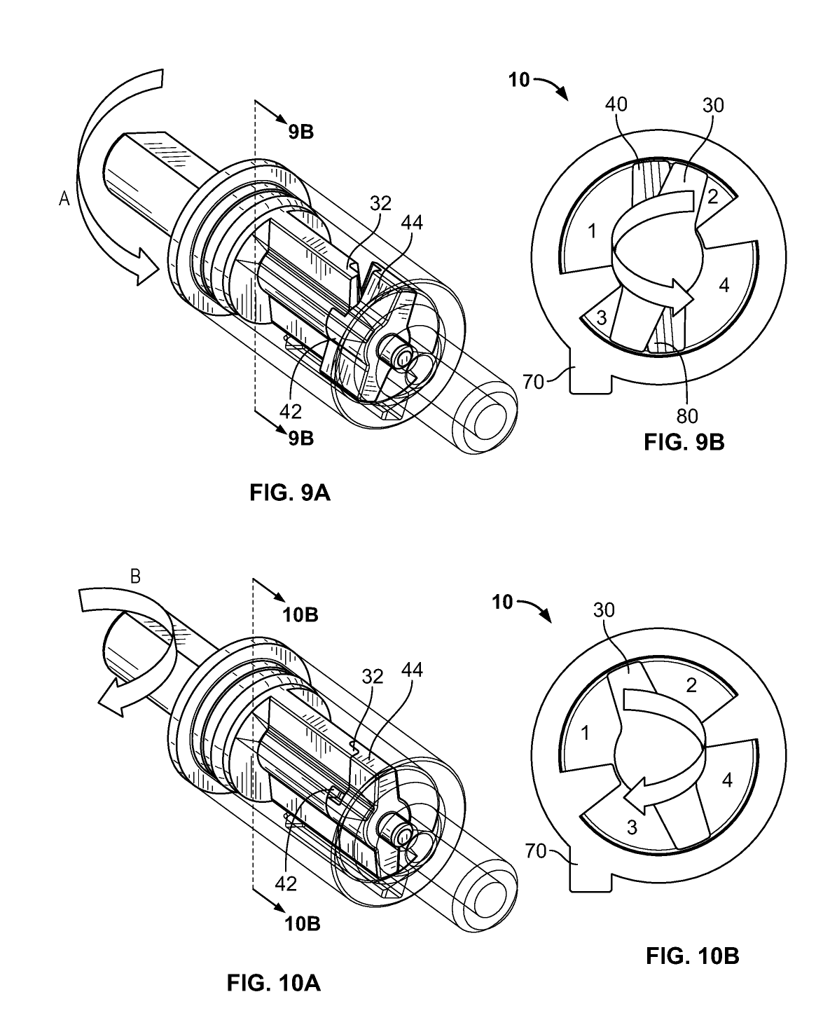

Viscous fluid exchanges happen between chambers 1 and 2 and 3 and 4 during rotation, as illustrated in FIGS. 9A-9B. As first shown in FIG. 9A, the core 30 is being rotated in a counter clockwise fashion (i.e., in the A direction). By rotating the core in the A direction, this “opens” the valve 40 meaning that the lips 44 of the valve 40 and the wings 32 of the internal portion of the core 30 separate from each other rotationally greater than a predetermined angle, thereby allowing fluid to flow therebetween through a passageway 80 created by such separation. In this regard, fluid is being freely exchanged, primarily from chambers 1 to 2 and 4 to 3 and secondarily from chambers 1 to 3 and 4 to 2. This is considered a rotation without resistance.

Contrarily, as shown in FIG. 9B, when the core 30 is being rotated in a clockwise fashion (i.e., in the B direction), the valve 40 becomes closed with the internal portion of the core 30 such that the lips 44 of the valve 40 mate with the wings 32 of the core so that the passageway 80 is now closed (in that fluid does not flow through the passageway 80). This means that the valve and the core resists fluid to flow between chambers via the passageway 80, especially in comparison to the embodiment shown in FIG. 9A, but only allows the fluid to flow in between the area circumferentially between the circumferential perimeter of the valve 40/core 30 and the inner periphery of the body 20. Such area when the valve is closed (i.e., when the core is rotated in the B direction when the lips 44 are mated with wings 32) is much less than the area created when the passageway 80 is opened (i.e., when the core is rotated in the A direction).

In FIG. 9B, when the valve is closed (i.e., when the core is rotated in the B direction when the lips 44 are mated with wings 32), fluid is being resistively exchanged, primarily from chambers 2 to 1 and 3 to 4 and secondarily from chambers 3 to 1 and 2 to 4.

In this regard, the valve dampens with the rotational movement of the core in one direction (e.g., the A direction) relative to rotational movement of the core in the opposite direction (e.g., the B direction).

Regarding the lugs 42 of the valve, the lugs 42 prevents the core 30 from rotating past a predefined angle relative to the valve 40 after the valve 40 has rotated away from the core and the core continues to rotate away from the valve in the A direction.

It is noted that an amount of resistance of fluid flow is adjustable by changing the size of the passageway formed by opening of the valve 40 when the core 30 rotates in the A direction.

This is shown in FIG. 10B, which illustrates the flow of fluid on the circumferential area between the circumference of the valve 40/core 30 and the inner periphery of the body 20.

### Additional/Alternative Embodiment

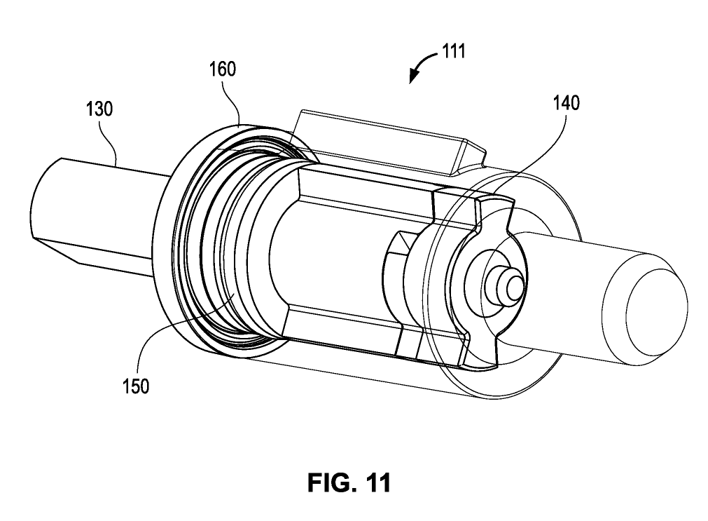

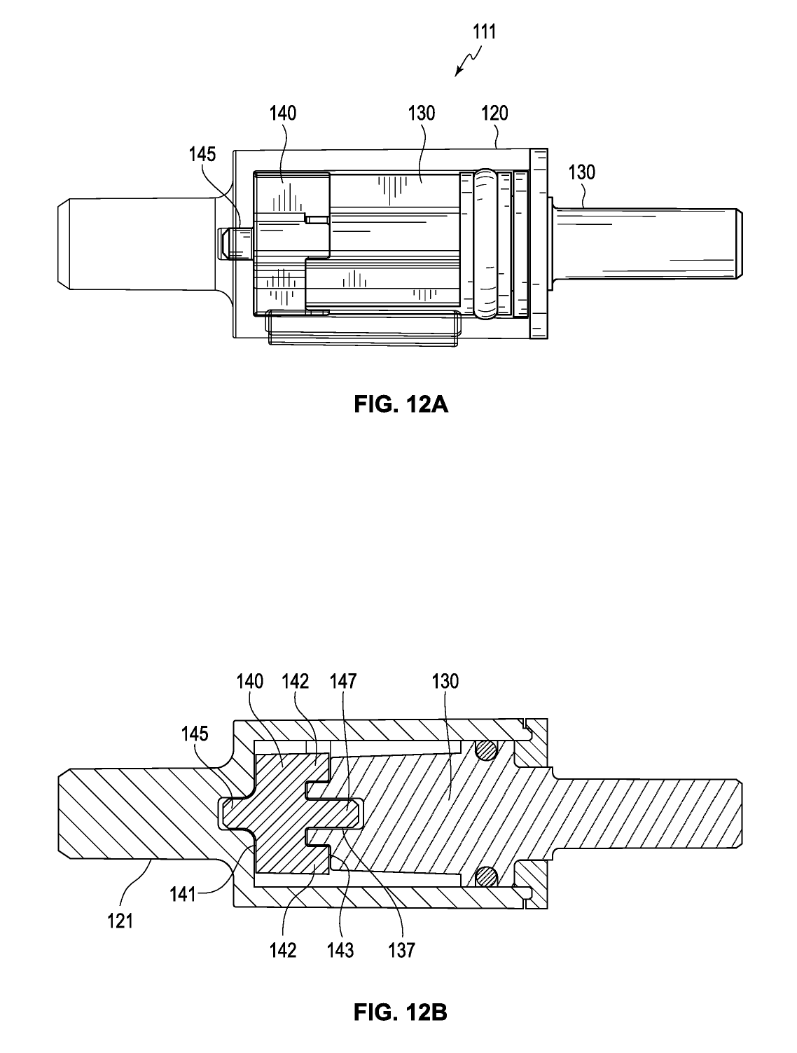

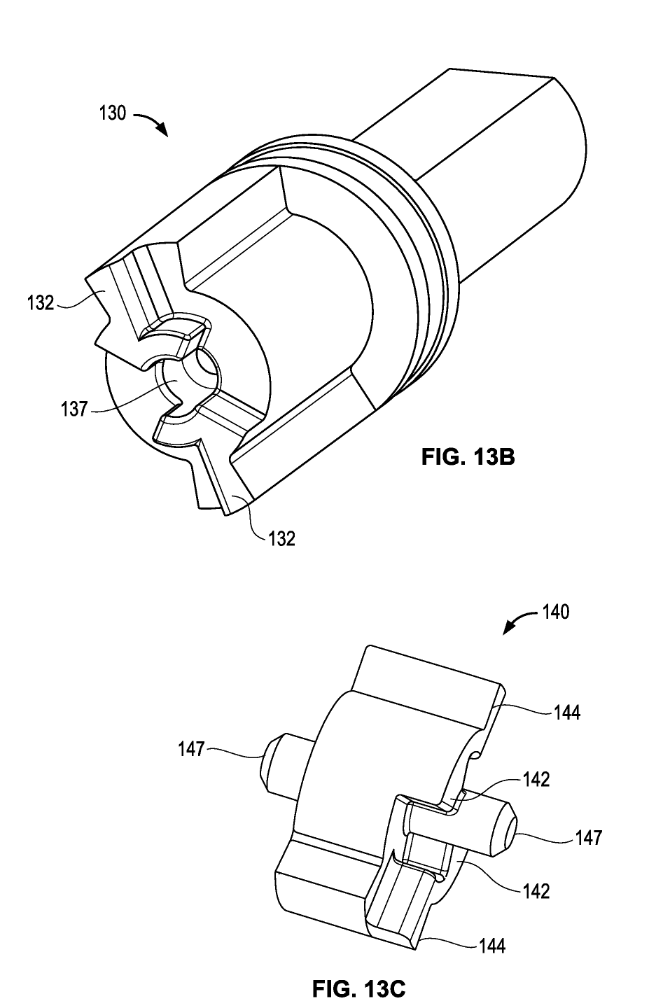

FIGS. 11-13C illustrates a fluid-valve damper 111 according to various embodiments. The embodiment of FIGS. 11-13C are a varied of the embodiment shown in As shown in FIGS. 11 and 13A, components of the fluid-valve damper 111 according to an embodiment are shown and may include a body 120, a core 130 rotationally attached to the body 120, a valve 140 rotationally attached to the core 130, an o-ring 150, and an end cap 160. The body 120, the core 130, the valve 140, the o-ring 150, and the end cap 160 correspond to the body 20, the core 30, the valve 40, the o-ring 50, and the end cap 60, respectively, except at least the core 130 and the valve 140 are different from core 30 and valve 40, respectively, as is discussed below.

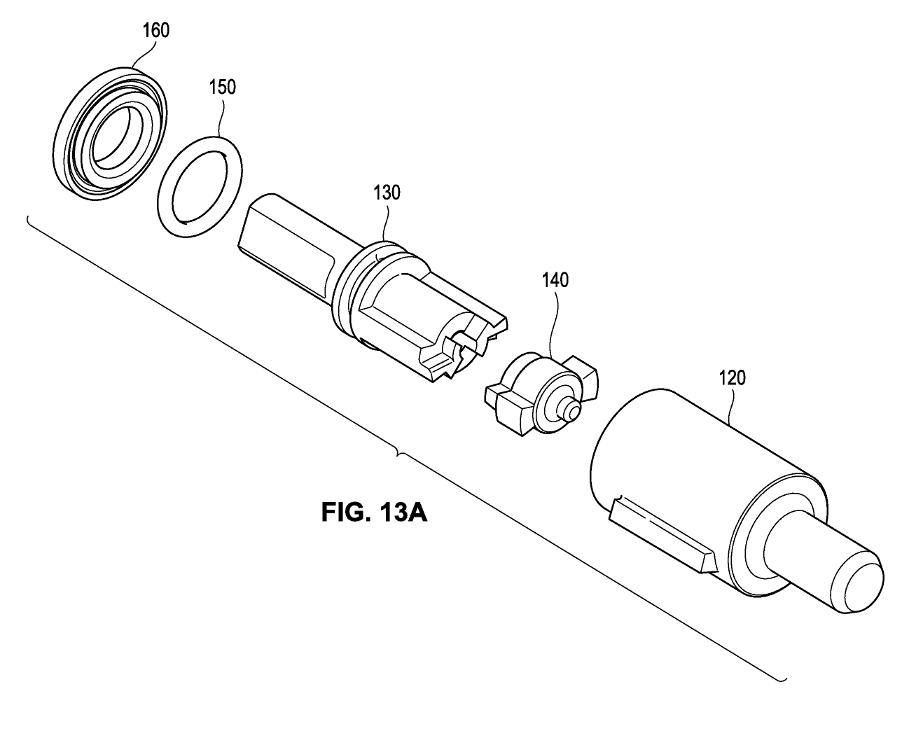

The core 130 does not have a pin that extends through the valve 140. In this regard and as illustrated in FIGS. 12B and 13C, a pin 145 of the valve 140 extends from a first end 141 of the valve 140 away from the valve and the core 130. The pin 145 extends toward a first portion 121 of the body 120 to rotationally connect the first portion 121 of the body 120, where the first portion 121 of the body 120 is located proximate to a side of the valve 140 opposite of the core 130. Pin 145 is configured to allow the valve 140 to directly and rotational attach with the first portion 121 of body 120, thereby allowing the valve 140 to rotate about an axis shared with the body 120 and the valve 130. This axis may also be the same as that the core 130 rotates about as well.

Also, the valve 140 has also has a second pin 147 that extends from a second end 143 of the valve 140 toward the core 130. The second pin 147 is inserted into a cavity 137 of the core 130 so that the second pin 147 allows the valve to rotate relative to the core 130 when the pin 145 of the valve 140 is in the cavity 137 of the core 130. The cavity 137 of the core 130 is illustrated in FIGS. 12B and 13B and is defined as a hole within a sidewall of the core 130 at the rotational axis of the valve 130 and/or the rotational axis of the core 130. As mentioned above the rotational axis of the valve 130 and/or the rotational axis of the core 130 may be the same axis.

In this regard, the valve 140 rotates about the rotational axis of the valve 140 relative to the body 120 and/or relative to the core 130 using the pins 145, 147 of the valve interposed between the core 130 and the body 120. The pins 145, 147 may be integrally formed with the valve 140 as a unitary part of the valve.

The body 120 houses the core 130 and the valve 140 which are both rotationally attached to the body 120. The core 130 has a portion extending outside of the body 120 and a portion that is completely within the body 120 and that attaches rotationally to the valve 140. In this regard, when the external portion of the core 130 is rotated, the internal portion of the core 130 rotates. Some embodiments of the components of the damper 111 are explicitly discussed in more depth below.

The function of the core 130 is to: provide mounting to the rotational part of the device/assembly that is being dampened (e.g. toilet seat and lid), provide bearing surface for the valve 140, transfer rotational driving force to open and close the valve 140, contains the viscous “grease” in the intended chamber(s) during the rotational operation, and provides bearing surface for the o ring 150.

It is noted that core 130 is formed into a single unitary piece which extends along an axis of rotation of the core 130. Furthermore, the core 130 has a proximate end that extends outside of the body 120 and connects to a device that is desired to be controlled and also has a distal end that ends directly to only the valve 140 and connected via cavity 137 and pin 147.

The valve 140 is rotationally attached to the distal end of the core 130 by the cavity 137 and pin 147 of valve 140 and includes, at a proximate end of the valve 140, at least one wing 144 shaped to mate with a lip 132 of the core 130. A distal end of the valve 140 directly contacts the body 120 so that the valve 140 is sandwiched directly between the core 130 and the body 120.

The valve 140 has a lug portion 142 which intersects with the internal portion of the core 130 when the internal portion of the core 130 is rotated past a predefined rotational amount. The lugs 142 prevents the core 130 from rotating past a predefined angle relative to the valve 140 after the valve 140 has rotated away from the core and the core continues to rotate away from the valve in the A direction (A direction shown in FIGS. 1 and 9A-B).

The function of the lips 132, wings 144, and lugs 142 are the same as the lips 32, wings 44, and lugs 42, respectively, as discussed above.

Moreover, operation of the valve 140 and the core 130 occurs similar than that as discussed in FIGS. 9-10.

1. A fluid valve damper for a toilet lid, comprising:
a core having, at a proximate end of the core, an extension configured to connect to the toilet lid, the core having at least one lip at a distal end of the core;
a body that houses a fluid and a portion of the core within the housing having an opening that allows for the extension of the core to extend outside of the body;
a valve that is rotationally attached to the distal end of the core and comprises, at a proximate end of the valve, at least one wing shaped to mate with the at least one lip of the core, wherein a distal end of the valve directly contacts the body so that the valve is sandwiched directly between the core and the body,
wherein the core is configured to rotate: (1) in a first direction to thereby create a passage between the at least one lip of the valve and the at least one wing of the core for fluid to flow therethrough, and (2) in a second direction that is opposite the first direction so that the at least one wing of the core contacts and mates with the at least one lip of the valve so that further rotation of the core in the second direction forces the core and the valve to rotate together while disallowing fluid to flow between the passage.

2. The fluid valve damper of claim 1, wherein an amount of resistance of fluid flow is adjustable by changing the size of the area formed by opening of the passage when the core rotates in the first direction.

3. The fluid valve damper of claim 1, wherein rotation in the second direction allows the fluid to flow between a second passage that is located between the body and a portion of the valve that is adjacent to the body.

4. The fluid valve damper of claim 1, wherein the body comprises an end that connects directly to the toilet lid.

5. The fluid valve damper of claim 1, wherein the valve further comprises at least one lug that prevents the core from rotating past a predefined angle in the second direction.

6. The fluid valve damper of claim 1, wherein the at least one wing includes two wings, and the at least one lip comprises two lips, whereby each lip is configured to mate with each respective lip only when the core rotates in the second direction.

7. The fluid valve damper of claim 1, wherein the core comprises a second extension that extends along an axis of rotation of the core, wherein the second extension extends through the valve along an axis of rotation of the valve.

8. The fluid valve damper of claim 1, wherein the core comprises a cavity that receives a pin extending from a valve, the cavity and the pin are aligned along a common rotational axis.

9. The fluid valve damper of claim 1, wherein the body is a unitary piece that connects with the toilet lid and also houses the core and the valve.

10. A fluid valve damper comprising:
a core having, at a proximate end of the core, an extension configured to connect to a device, the core having at least one lip at a distal end of the core;
a body that houses a fluid and a portion of the core within the housing having an opening that allows for the extension of the core to extend outside of the body;
a valve that is rotationally attached to the distal end of the core and comprises, at a proximate end of the valve, at least one wing shaped to mate with the at least one lip of the core, wherein the valve is disposed between the core and the body,
wherein the core is configured to rotate: (1) in a first direction to thereby create a first passage between the at least one lip of the valve and the at least one wing of the core for fluid to flow therethrough, and (2) in a second direction that is opposite the first direction so that the at least one wing of the core contacts and mates with the at least one lip of the valve so that further rotation of the core in the second direction forces the core and the valve to rotate together while disallowing fluid to flow between the first passage.

11. The fluid valve damper of claim 10, wherein rotation in the second direction allows the fluid to flow between a second passage that is located between the body and a portion of the valve that is adjacent to the body, such that fluid flow through the first passage is greater when the core is rotating in the second direction than fluid flow through the second passage when the core is rotating in the first direction.

12. The fluid valve damper of claim 10, wherein the valve further comprises at least one lug that prevents the core from rotating past a predefined angle in the second direction.

13. The fluid valve damper of claim 10, wherein the at least one wing includes two wings, and the at least one lip comprises two lips, whereby each lip is configured to mate with each respective lip only when the core rotates in the second direction.

14. The fluid valve damper of claim 10, wherein the core comprises a second extension that extends along an axis of rotation of the core, wherein the second extension extends through the valve along an axis of rotation of the valve.

15. The fluid valve damper of claim 10, wherein the core comprises a cavity that receives a pin extending from a valve, the cavity and the pin are aligned along a common rotational axis.

16. The fluid valve damper of claim 10, wherein the body is a unitary piece that connects with the toilet lid and also houses the core and the valve.

17. A method of operating a fluid valve damper, the method comprising:
rotating a core in a first direction to thereby create a first passage between at least one lip of a valve and at least one wing of the core for fluid to flow therethrough, the core comprising an extension at a proximate end of the core and at least one lip at a distal end of the core, the valve being rotationally attached to the distal end of the core and being sandwiched between the core and the body, wherein the at least one wing is shaped to mate with the at least one lip of the core, and
rotating the core in a second direction that is opposite the first direction so that the at least one wing of the core contacts and mates with the at least one lip of the valve so that further rotation of the core in the second direction forces the core and the valve to rotate together while disallowing fluid to flow between the first passage.

18. The method of claim 17, wherein rotation in the second direction allows the fluid to flow between a second passage that is located between the body and a portion of the valve that is adjacent to the body, such that fluid flow through the first passage is greater when the core is rotating in the second direction than fluid flow through the second passage when the core is rotating in the first direction.

19. The method of claim 17, wherein the valve further comprises at least one lug that prevents the core from rotating past a predefined angle in the second direction.

20. The method of claim 17, wherein the at least one wing includes two wings, and the at least one lip comprises two lips, whereby each lip is configured to mate with each respective lip only when the core rotates in the second direction.
